(19) United States
(12) Patent Application Publication
(10) Pub. No.: US 2025/0387291 A1
(43) Pub. Date: Dec. 25, 2025

(54) MASSAGE MODULE

(71) Applicants: Dongguan Qunan Technology Co., Ltd., Dongguan (CN); Shenzhen Zhonghongtian Technology Co., Ltd., Shenzhen (CN)

(72) Inventors: Bo Yan, Dongguan (CN); Hong Zhang, Shenzhen (CN)

(21) Appl. No.: 18/921,294

(22) Filed: Oct. 21, 2024

(30) Foreign Application Priority Data
Jun. 21, 2024 (CN) 202421443425.5

(51) Int. Cl. A61H 19/00; A61H 23/02

(52) U.S. Cl. CPC A61H 19/44; A61H 19/34; A61H 23/0254; A61H 2201/0153; A61H 2201/1215

(57) ABSTRACT

A massage module comprising: a head portion, a handle; and a connecting portion, the connecting portion comprising a sub-massage portion configured to providing a second stimulus to the vagina, the sub-massage portion comprising: a housing; a recess formed in the housing, the recess defining a movement space in the housing and a first opening intercommunicating the movement space inside the housing to an exterior space outside of the housing, a driving device received in a cavity defined in the handle, the cavity being communicating with the movement space; and a massage head accommodated in the movement space, wherein at least a portion of the massage head protrudes out of the movement space via the first opening, and the driving device drives the at least a portion of the massage head to reciprocating move in a linear direction in the movement space, so as to generate the second stimulus.

### CROSS-REFERENCE TO RELATED APPLICATIONS

This application claims the benefit of priority to Chinese Patent Application Number 202421443425.5 filed on Jun. 21, 2024, in the China National Intellectual Property Administration. The entire contents of the above-identified application are hereby incorporated by reference.

### TECHNICAL FIELD

The present disclosure relates to a massage module.

### BACKGROUND

With the development of society and economy, the pace of life is getting faster, and the pressure of work is getting higher. Thus, the demand for physical relaxation is increasing, and consumer-grade massage module is becoming popular. In order to meet consumers' demands, a variety of massage modules are available in the market.

However, most of the massage elements of the massage modules, in particularly the massage elements in sex toys, are limited to linear reciprocating motions. Such massage devices are relatively simple in actions, and the massage heads of the massage devices resist against portions of a human body during operation, it may be difficult to manipulate.

### BRIEF DESCRIPTION OF DRAWINGS

Embodiments of the present disclosure will now be described, by way of embodiment, with reference to the attached figures. The structure, operation, and advantages of the present invention will become further apparent upon consideration of the following description taken in conjunction with the accompanying figures. The figures are intended to be illustrative, and not limiting.

FIG. 1 is an isometric, assembled view of a of a massage module according to a first embodiment of the present disclosure, the massage module including a shell and a massage head.

FIG. 2 shows a perspective view of the massage module after disassembling a cover from the massage module according to the first embodiment of FIG. 1.

FIG. 3 is a side diagram view of the massage module after disassembling the cover according to the first embodiment of FIG. 1.

FIG. 4 illustrates a motion of the massage head according to the first embodiment of FIG. 1.

FIG. 5 is an exploded view of the massage module, after disassembling the cover, according to the first embodiment of FIG. 1.

FIG. 6 is a perspective view of the cover of the massage module according to the first embodiment of FIG. 1.

FIG. 7 is an exploded view of the cover and the shell of the massage module according to the first embodiment of FIG. 1.

FIG. 8 is a cross-sectional view of the massage module according to the first embodiment of FIG. 1.

FIG. 9 is a perspective view of a partial structure of the massage module according to the first embodiment of FIG. 1.

FIG. 10 is a schematic diagram of a matching relationship between a screw and a plug of the massage module according to the first embodiment of FIG. 1.

FIG. 11 is a perspective view of a sliding block of the massage module according to the first embodiment of FIG. 1.

FIG. 12 is a schematic diagram of a matching relationship between the sliding block and the shell of the massage module according to the first embodiment of FIG. 1.

FIG. 13 is a perspective view of a cover of the massage module according to a second embodiment of the present disclosure.

FIG. 14 is an isometric, assembled view of a massage module according to a third embodiment of the present disclosure, the massage module including a shell and a massage head.

FIG. 15 is a perspective view of the massage module, after disassembling a cover, according to a fourth embodiment of the present disclosure.

FIG. 16 is a perspective view of the massage module according to a fourth embodiment of the present disclosure, wherein the massage head slides from a first position to a second position.

FIG. 17 is an isometric, assembled view of a massage module according to a fifth embodiment of the present disclosure, the massage module including a shell and a massage head.

### DETAILED DESCRIPTION

In the description that follows, numerous details are outlined to provide a thorough understanding of the present invention. It will be appreciated by those skilled in the art that variations of these specific details are possible while still achieving the results of the present invention.

Exemplary illustrative embodiments of the invention should be interpreted as example(s) and non-limiting. The relationship between various arms, where they are located, their composition(s), their operation and sometimes their sizes relative to the desired operation of the invention are not significant.

### First Embodiment

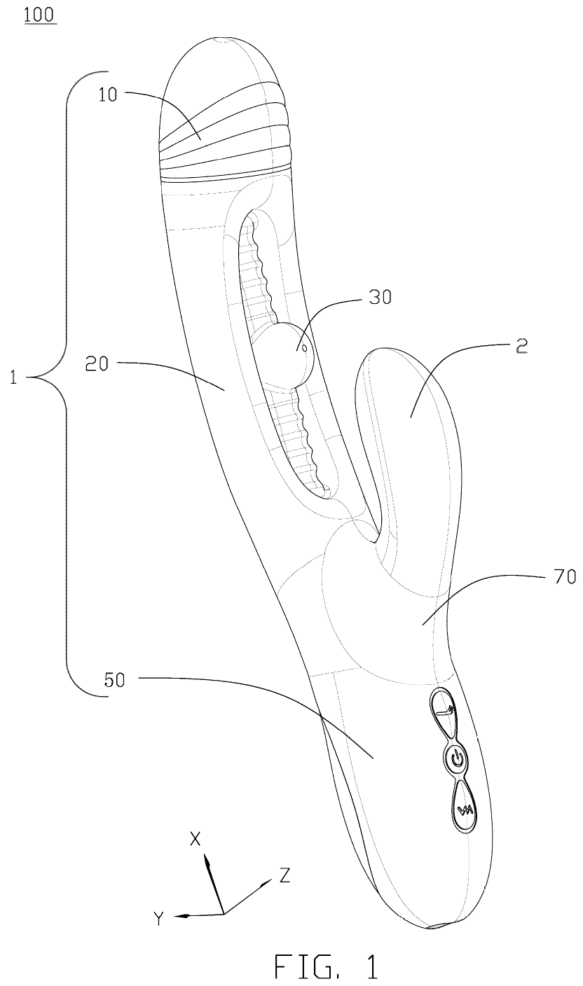

Referring to FIG. 1 to FIG. 12, which show a massage module 100 of the first embodiment of the present disclosure. The massage module 100 is capable of being inserted into a human body to provide multi-stimuluses to the user. The massage module 100 includes a main massage portion 1 most of which is inserted into the human body, for example, a vagina, a vice massage portion 2 extending from the main massage portion 1, a massage head 30 located in the main massage portion 1, a driving device 60 configured to control the main massage portion and/or other massage functions of the massage module 100, and a shell 90 configured to receive function elements, such as the driving device 60 of the massage module 100.

In an exemplary embodiment of the present disclosure, a length of the vice massage portion 2 is shorter than that of the main massage portion 1. It can be understood that the length relationship and/or length ratio between the main massage portion 1 and the vice massage portion 2 are adjustable.

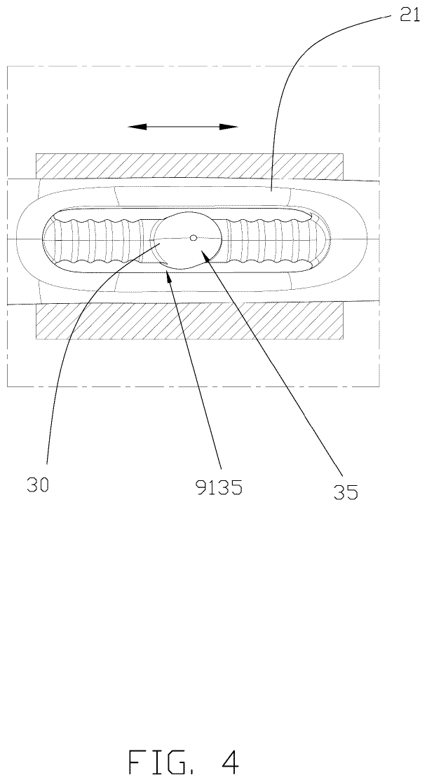

The main massage portion 1 includes a head portion 10, a connecting portion 20 and a handle 50. The head portion 10 is configured to be inserted into the vagina along an insertion direction X so as to provide a first stimulus to a first area of the vagina. The first stimulus can be for example a sensation of stimulation generated by at least one of friction, tapping, or vibration applied on the object to be contacted. In one example embodiment, the frictional motion generated by the action of inserting or withdrawing from the body forms the first stimulus. The connecting portion 20 connects the head portion 10 and the handle 50. The connecting portion 20 comprises a sub-massage portion 21 configured to provide a second stimulus to the object to be contacted. The massage head 30 corresponds to the sub-massage portion 21, and reciprocally and linearly moves with respect to the main massage portion 1 under the control of the drive device 60. In one example embodiment of the present disclosure, the massage head 30 performs synchronous or asynchronous linear movement following with the movement of the head portion 10. Referring also FIG. 4, when the massage head 30 is inserted into the human body, the sub-massage portion 21 is also inserted into the human body, and then provides a second stimulus to the body, the second stimulus is generated by the linear movement of the massage head 30.

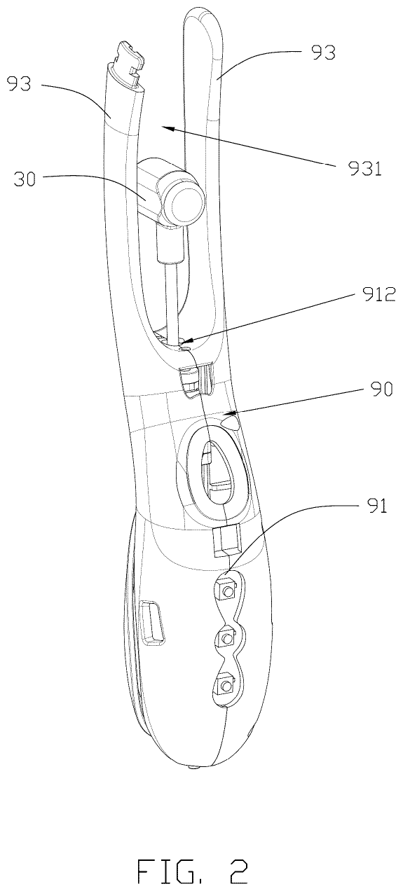

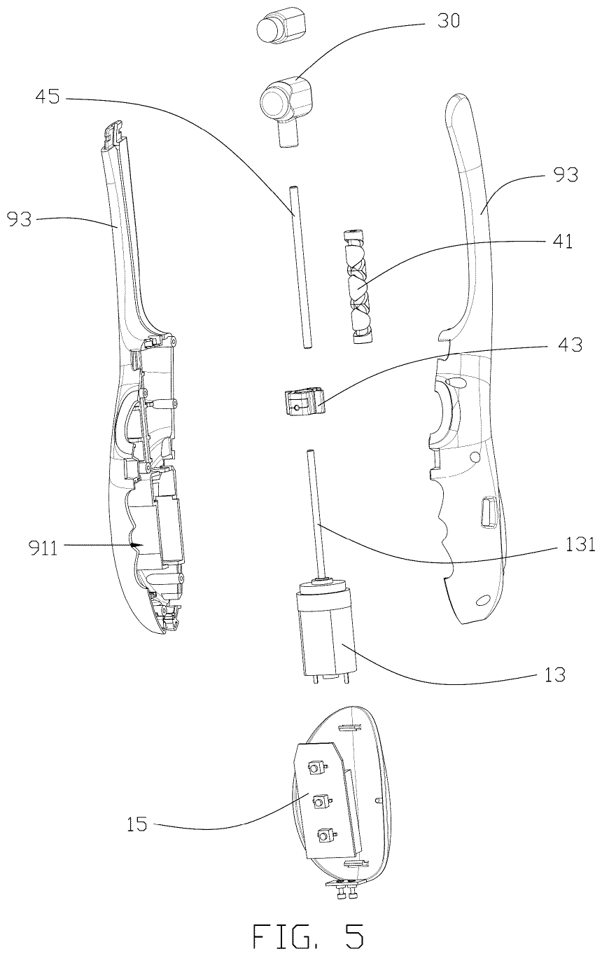

The handle 50 includes a handle housing 91 and several control items located therein. The driving device 60 is correspondingly received into a cavity 911 (as shown in FIG. 5) defined by the handle housing 91. In one exemplary embodiment of the present disclosure, the handle housing 91 is a part of the shell 90, and is integrated formed with other portions of the shell 90. A through opening 912 (as shown in FIG. 2) is defined in a wall of the handle housing 91 facing towards the connecting portion 20. A transmission function element of the driving device 60 is connected to the massage head 30 via the through opening 912, thereby the driving device 60 drives the massage head 30 to move. The shell 90 comprises two support arms 93 extended from two opposite edges of a top end of the handle housing 91 along the length direction of the main massage portion 1. The length direction is parallel to the insertion direction X. The two support arms 93 are arranged at an interval. handle 50A hollow space 931 is defined between the two support arms 93. The hollow space 931 is also formed by a recess penetrates through the shell 90 in a thickness direction of the shell 90 perpendicular to the length direction, thereby forming a first opening 9311 and a second opening 9313 opposite to the first opening 9311. Both the first opening 9311 and the second opening 9313 are communicated with the hollow space 931, and are intercommunicating the hollow space 931 inside the shell 90 with an outside environment space out of the shell 90. In some exemplary embodiments of the present disclosure, the hollow space 931 can be for example a recess formed in the shell 90 by inwardly depressed in the thickness direction of the shell 90 without penetrating through the shell 90, and the recess includes side walls defined by the two support arms 93, a bottom wall (not labeled) defined by the remained shell and an opening (e.g. the first opening 9311) communicating with the hollow space 931. The massage head 30 is received in the hollow space 931 and is capable of linearly reciprocally moving with respect to the main massage portion 1 under the control of the driving device 60, and at least a portion of a massage surface 35 of the massage head 30 is capable of protruding out of the shell 90 via at least one of the first opening 9311 and the second opening 9313. When the massage head 30 performs the linearly reciprocally movement in the length direction, the massage surface 35 repeatedly applies pressure or simulation to different positions of a specific area of the object being contacted following with the movements of the massage head 30.

A gap 9315 is formed between the inner wall of the two support arms 93 and the outer wall of the massage head 30, thereby the massage head 30 does not contact the inner sidewalls of the two support arms 93.

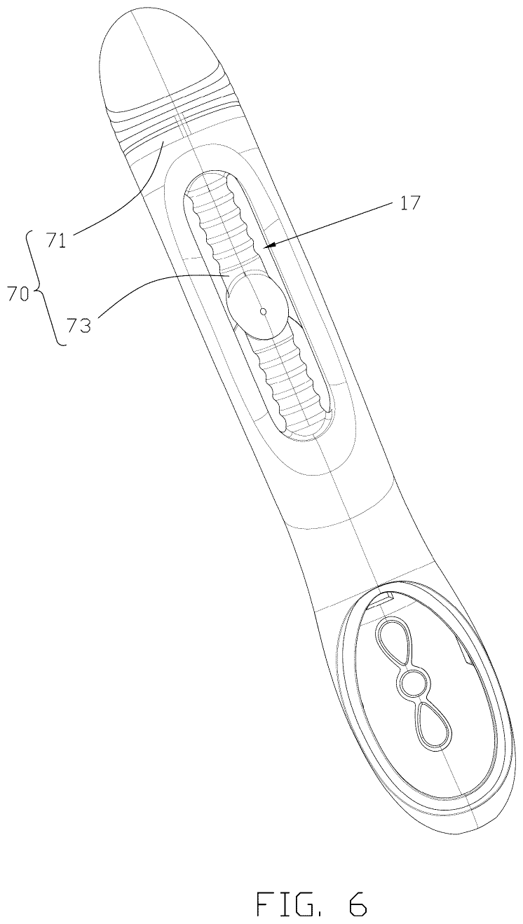

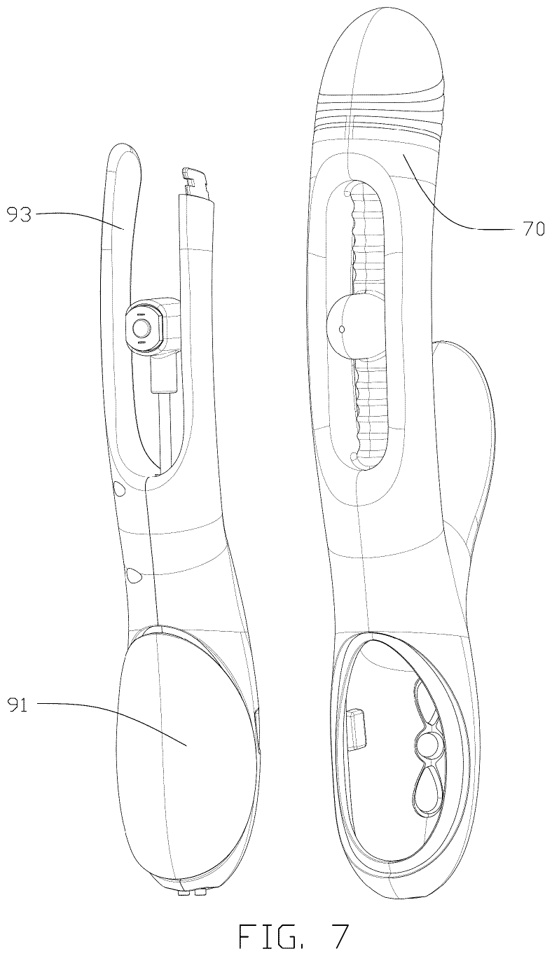

Referring to FIG. 6 and FIG. 7, a cover 70 made of flexible material with elasticity covers outer surfaces of the shell 90 except the first opening 9311 and the second opening 9313, thereby the first opening 9311 and the second opening 9313 are communicated with an outside environment space out of the shell 90. In some exemplary embodiments of the present disclosure, the side of the cover 70 close to the head portion 10 forms a movement space 17 defined by the hollow space 931. The movement space 17 is long arc-shaped hole. The massage head 30 is installed within the movement space 17 and can move reciprocally with respect to the shell 90. In this embodiment, the cover 70 completely covers the two support arms 93 but does not cover the upper and lower sides of the hollow space 931, thereby the movement space 17 and the hollow space 931 coincide.

The cover 70 covers the main massage portion 1, the massage head 30 and the vice massage portion 2 to play a waterproof role. The shell 90 is made of solid material, and the cover 70 provided with a first cover 71 and a second cover 73. The second cover 73 is installed telescopically within the hollow space 931 and covers the items in the hollow space 931. The first cover 71 is used for covering the massage module 100 expect the items in the hollow space 931. The sliding motion of the massage head 30 drives the second cover 73 to telescopically move with respect to the shell 90. The ends of the massage head 30 protruding the shell 90 are covered by the cover 70, and the cover 70 is curved structure. one end of the second cover 73 is fixed to the handle housing 91 of the shell 90 and covers the extension bar 45 and the massage head 30. The other end of the second cover 73 connected to the bottom of the head portion 10 The second cover 73 is a folding structure. Further, in the first direction X of the shell 90, when the massage head 30 moves from the handle 50 towards the head portion 10, the portion of the second cover 73 close to the head portion 10 is compressed, while the portion far from the head portion 10 is stretched. When the massage head 30 moves from the head portion 10 towards the handle 50, the portion of the second cover 73 far from the head portion 10 is compressed, while the portion close to the head portion 10 is stretched, so as to move telescopically follow the massage head 30.

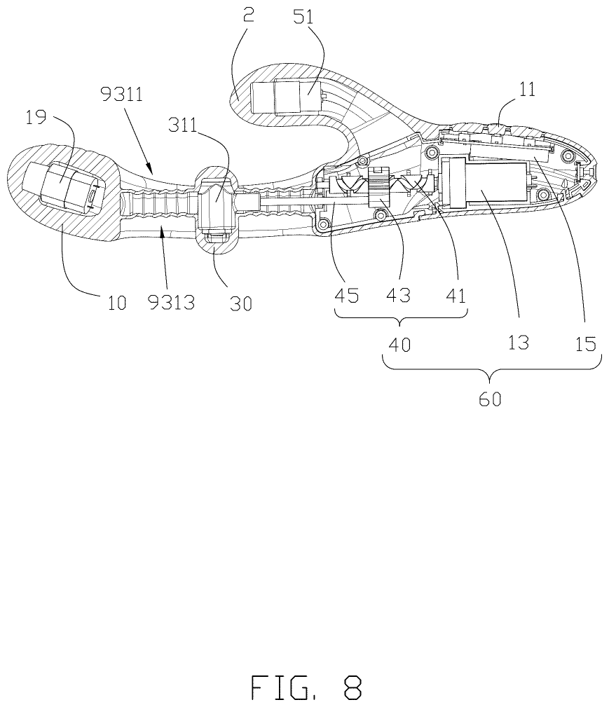

Referring to FIG. 8, the inside of the shell 90 forms various brackets protruding with respect to the inner wall of the shell 90 and the brackets are used for fixing the positions of the driving device 60, a circuit board 15 and others. The shell 90 is made of hard material, so as to improve the bracing stability, enhance durability and extend the service life of the massage module 100. The back end of the shell far from the head portion 10 provided with a control member 11. The control member 11 is in direct connected to the circuit board 15 and used to control the massage module 100. It can be understood that the preferred position of the control member 11 is at the back end of the massage module 100 to avoid being far from the battery, thus reducing current transmission loss. It can be understood that the positions of the control member 11 are adjustable, or it can be replaced by a remote device or electronic product for control.

Furthermore, the shell 90 is made of a first material, the massage head 30 is made of a second material and the cover 70 is made of a third material. The elasticity of the first material is less than the second material and the elasticity of the third material is more than the second material.

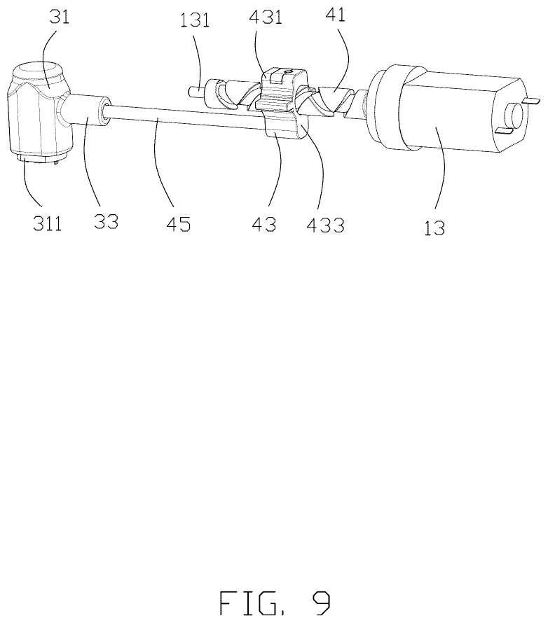

Referring to FIG. 2, FIG. 5, FIG. 8 and FIG. 9, the driving device 60 is installed within the cavity 911 of the shell 90. The driving device 60 includes a driving member 13, the circuit board 15 and a transmission mechanism 40. A portion of the transmission mechanism 40 extending and protruding towards the hollow space 931 through the through opening 912 and connect to the massage head 30. The slide of the massage head 30 in the hollow space 931 is performed by the coordinate between the transmission mechanism 40 and the driving member 13.

The driving member 13 is fixedly installed within the cavity 911, with an elongated rotating shaft 131 extending from one end of the driving member 13, used for installing the transmission mechanism 40.

The transmission mechanism 40 includes a screw 41, a sliding block 43 and the extension bar 45. The screw 41 has a perforation 413 in the length direction. The rotating shaft 131 is inserted into one end of the perforation 413 and extends through the other end of the perforation 413, so that the screw 41 is sleeved on the rotating shaft 131. The rotating shaft 131 keeps rotating, driven by the driving member 13, while drives the screw 41 to rotate. The sliding block 43 is movably sleeved on the screw 41. One end of the extension bar 45 connected to the sliding block 43 and the other end extends towards the hollow space 931 through the through opening 912 until it is connected to the massage head 30. In some exemplary embodiments of the present disclosure, the extension bar 45 and the screw 41 are parallel to each other and arranged at an interval.

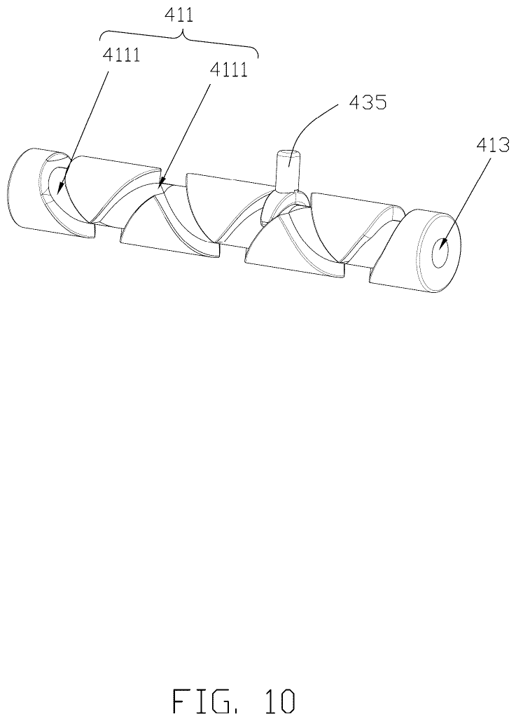

Referring to FIG. 9 and FIG. 10, the screw 41 is a long and hollow cylindrical tube with a circular cross-section. The screw 41 along the length direction forms a spiral sliding groove 411. The rotating shaft 131 keeps rotating, driven by the driving member 13, while drives the screw 41 to rotate. At this time, the sliding block 43 can move forward along the sliding groove 411 from the end of the screw 41 close to the driving member 13 towards the end of the screw 41 far away from the driving member 13, or can move backward along the sliding groove 411 from the end of the screw 41 far away from the driving member 13 towards the end of the screw 41 close to the driving member 13, so that the sliding block 43 reciprocating move with respect to the screw 41 through the sliding groove 411. The sliding groove 411 is consists of multiple inclined chutes 4111. The adjacent two inclined chutes 4111 are in a V-shaped and the two separated inclined chutes 4111 are parallel to each other, so that the adjacent three inclined chutes 4111 are in an incline N-shaped. It can be understood that the specific structure of the sliding groove 411 can be designed according to actual demands.

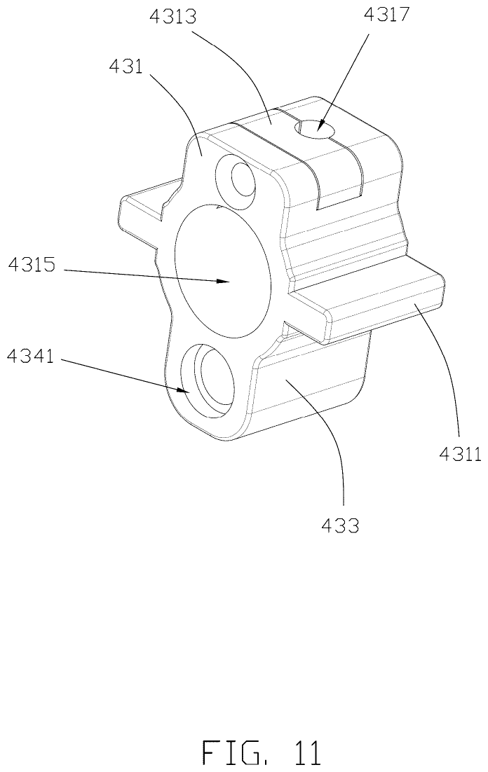

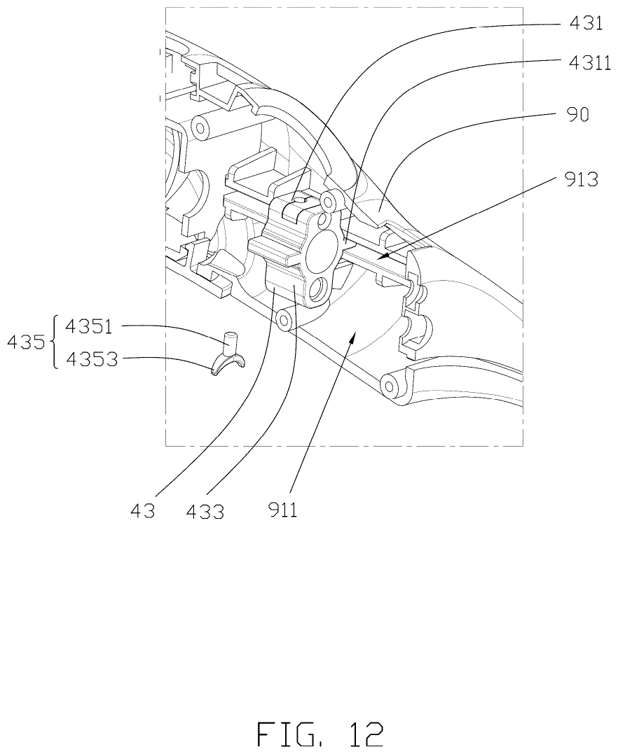

Referring to FIG. 9, FIG. 11 and FIG. 12, the sliding block 43 is rectangular and includes a first portion 431 and a second portion 433 extending and protruding from the first portion 431. The first portion 431 is connected to the screw 41 and the second portion 433 is connected to the extension bar 45. The first portion 431 and the second portion 433 are integrally formed structure. The middle of the first portion 431 defines a first through hole 4315, which through the first portion 431 in the length direction. The screw 41 inserted into the first through hole 4315, so that the sliding block 43 is sleeved on the screw 41. The top of the first portion 431 far away from the second portion 433 defines a second through hole 4317, and the second through hole 4317 is connected to the first through hole 4315. A limiting block 4313 and a plug 435 installed on the second through hole 4317. The limiting block 4313 contact the plug 435, thereby the limiting block 4313 prevents the plug 435 from moving in the second through hole 4317. A portion of the plug 435 is accommodated in the second through hole 4317 and contacted the sliding block 43. The other portion of the plug 435 is extended to the first through hole 4315 through the second through hole 4315 and contacted the sliding groove 411.

The plug 435 includes a cylindrical rotating end 4351 that can rotate in the second through hole 4317 and an arc sliding end 4353. The rotating end 4351 and the sliding end 4353 are integrally formed structure. The sliding end 4353 in direct engaged in the sliding groove 411. The radian of the sliding end 4353 and the sliding groove 411 are equal, that is, the sliding end 4353 is completely conformed to the inner wall of the sliding groove 411. The two side of the first portion 431 along the width direction extend and form a sliding vane 4311. The inner wall of the shell 90 extends inwards to form two protrusions at an interval. A sliding rail 913 is formed between the two protrusions. The upper wall and the lower wall of the sliding rail 913 are bonded to the sliding vane 4311, so that the upper wall and the lower wall limit the sliding vane 4311 to move up and down, and thus the sliding block 43 cannot move up and down with respect to the shell 90.

The middle of the second portion 433 defines a third through hole 4331, the opening of the third through hole 4331 is the same as the first through hole 431. One end of the extension bar 45 is directly inserted into the third through hole 4331 so as to connect to the sliding block 43. The extension bar 45 and the screw 41 are parallel to each other and arranged at an interval.

Referring to FIG. 9, the massage head 30 is T-shaped and includes a raised portion 31 and a connecting portion 33 that extends from the raised portion 31. The connecting portion 33 is perpendicular to the raised portion 31. The connecting portion 33 is fixedly connect to the extension bar 45. Two ends of the raised portion 31 protrude outside the shell 90 through the hollow part, that is, the two ends of the raised portion 31 protrude outside the two support arms 93. Two ends of the raised portion 31 form at least one opening and fixedly install a second motor 311. The second motor 311 is a vibration motor. The second motor 311 can vibrate by operating the control member 11. Through the cooperation of the driving device 60 and the second motor 311, the massage head 30 can produce a vibration effect while sliding, thereby enhancing the massage experience for users. It can be understood that the vibration speed of the second motor 311 can be controlled by the control member 11. It can be understood that the driving device 60 and the second motor 311 are independent structures, which means that the massage head 30 can only slide, or only produce vibration, or produce vibration while sliding.

It can be understood that the massage head 30 can also be accommodated in the movement space 17 and does not protrude outside the shell 90. At this time, a portion of the second area of the vagina is inserted into the movement space 17 to contact to the massage head 30. When the massage head 30 reciprocating move in the movement space 17 with respect to the shell 90, the massage head 30 massages the second area of the vagina.

In other embodiments, the two ends of the massage head 30 respectively protrude from the two opening of the support arms 93 to protrude outside the shell 90. The second cover 73 envelopes the massage head 30. The second cover 73 is made of a flexible material with elasticity, thereby the second cover 73 that envelopes the ends of the massage head 30 is protruding. Furthermore, when the massage head 30 reciprocating move under the second cover 73 with respect to the shell 90, the second cover 73 does not prevent the massage head 30 from moving.

Referring to FIGS. 9-12, the principle of the massage head 30 sliding within the movement space 17 as follows.

The user operates the control member 11 to drive the drive member 13. The drive member 13 drives the rotating shaft 131 to rotate clockwise or counterclockwise, and the rotating shaft 131 drives the screw 41 to rotate. As the screw 41 rotating, the side wall of a first inclined chute 4111a extrudes the sliding end 4353 of the plug 435, so that the sliding end 4353 moves slowly towards a second inclined chute 4111b, and thus the position in the sliding groove 411 of the plug 435 is changed. The sliding vane 4311 is restricted by the sliding rail 913 and cannot move vertically, so that the plug 435 can only drive the screw 41 to slide horizontally along the screw 41. The sliding of the sliding block 43 drives the extension bar 45 to move horizontally, thereby causing the extension bar 45 to drive the massage head 30 to slide. When the sliding end 4353 of the plug 435 rotates from the first inclined chute 4111a to the last inclined chute 4111n, due to the constant rotation direction of the rotating shaft 131, the plug 435 returns to the first inclined chute along the inclined chute 4111 on the other side of the sliding groove 411. The sliding block 43 drives the extension rod 45 to retract, thereby the massage head 30 reciprocating slide or performs reciprocal linear motions. It can be understood that the sliding speed of the massage head 30 can be controlled, and its sliding speed depends on the rotational speed of the rotating shaft 131.

Furthermore, the transmission mechanism 40 can be driven by an externally applied force to rotate the plug 435, thereby changing the position of the plug 435 within the sliding groove 411.

Furthermore, the plug 435 and the screw 41 can rotate simultaneously, thereby changing the position of the plug 435 within the sliding groove 411.

Referring to FIG. 8, in this embodiment, the head portion 10 includes a first motor 11 and the vice massage portion 50 includes a third motor 51. Both the first motor 11 and the third motor 51 can produce vibration, thereby driving the head portion 10 and the vice massage portion 50 to produce vibration or swing at multiple angles. It can be understood that the first motor 11 and the third motor 51 are controlled independently of each other. It also can be understood that the number of the first motor 11 and the third motor 51 is not limited, and can be zero, one, or multiple.

In this embodiment, the tail end of the shell 90 provided with a charging port. The charging port is used to supply power to the driving member 13 and the circuit board 15. It can be understood that the power source of the massage module 100 can be an internal rechargeable battery or direct external power supply.

In this embodiment, the cover 70 completely covers the opposite sides of the two support arms 93, thereby forming the movement space 17 that overlaps with the hollow space 931. the massage head 30 can slide in the hollow space 931. The main massage portion 1, including head portion 10 and massage head 30, along with the vice massage portion 2, can simultaneously massage three different areas of the vagina, providing a wide massage area. Among them, the massage head 30 can reciprocating slide to massage through the driving device 60. The reciprocating sliding massage mode of the stimulating portion, combined with the vibration effect of the second motor, provides a better massage experience and is more practical.

### Second Embodiment

A description is given next of a second embodiment. For the sake of convenience of explanation, parts identical to those in the foregoing first embodiment shown in FIG. 1 to FIG. 12 are denoted by identical reference signs and are not described again for brevity. This embodiment is different in structure of the second cover 73a.

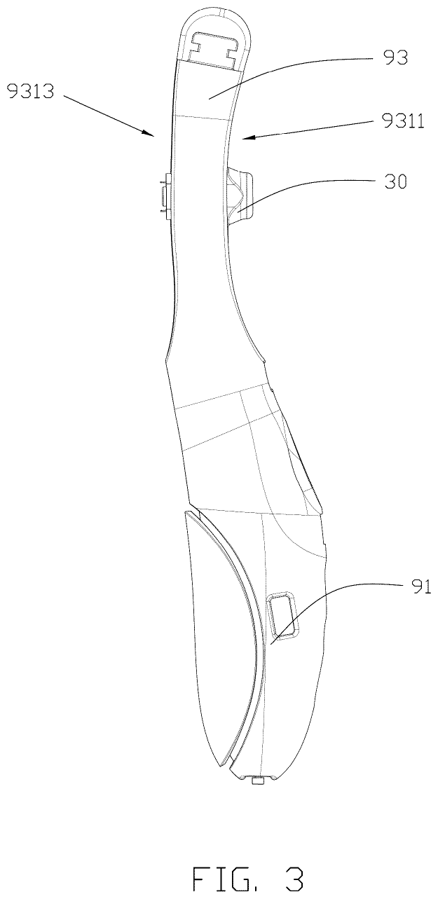

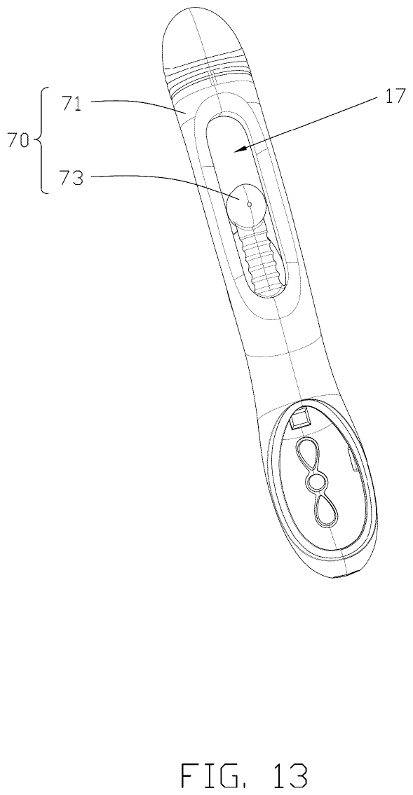

Referring to FIG. 1, FIG. 3 and FIG. 13, in this embodiment, the hollow space 931 is formed between the two support arms 93 and provides with the first opening 9311 and the opposite second opening 9313. When the cover 70 covers the massage module 100a, the hollow space 931 defines the movement space 17, which also provides with the first opening 9311 and the opposite second opening 9313. The massage head 30 is movably installed within the movement space 17 and the two ends of the massage head 30 extend and expose outside the shell 90 through the first opening 9311 and the second opening 9313.

The first cover 71 covers the handle housing 91 and the support arms 93. The second cover 73a covers the massage head 30 and the extension bar 45. One end of the second cover 73a is connected to the handle housing 91 and the other end is not connected to the bottom of the head portion 10.

The second cover 73a is a folding structure. Thus, in the first direction X of the shell 90, when the massage head 30 moves from the handle housing 91 towards the head portion 10, the portion of the second cover 73a far from the head portion 10 is stretched. When the massage head 30 moves from the head portion 10 towards the handle housing 91, the portion of the second cover 73a far from the head portion 10 is compressed, so as to move telescopically follow the massage head 30.

The second cover 73a is made of a flexible material with elasticity, thereby the second cover 73a that envelopes the ends of the massage head 30 is protruding. Furthermore, when the massage head 30 reciprocating move under the second cover 73a with respect to the shell 90, the second cover 73a does not prevent the massage head 30 from moving.

Also, the massage module 100a according to the present embodiment configured as described above can achieve advantages similar to those by the first embodiment.

### Third Embodiment

A description is given next of a third embodiment. For the sake of convenience of explanation, parts identical to those in the foregoing first embodiment shown in FIG. 1 to FIG. 12 are denoted by identical reference signs and are not described again for brevity. This embodiment is different in structure of the second cover 73a and the movement space 17.

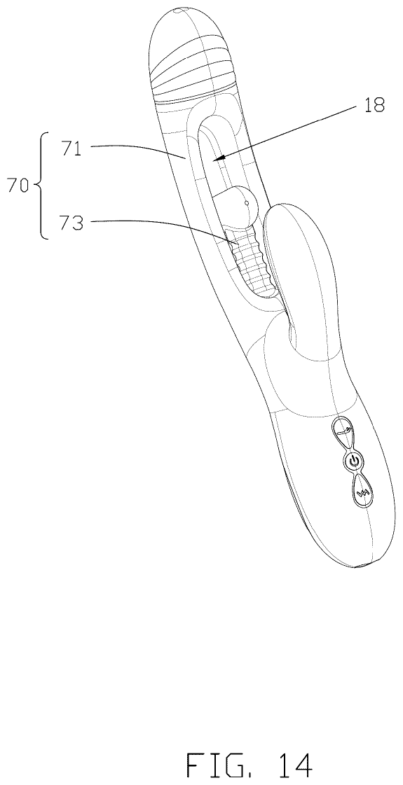

Referring to FIG. 1, FIG. 3 and FIG. 14, in this embodiment, the hollow space 931 is formed between the two support arms 93 and provides with the first opening 9311 and the opposite second opening 9313. When the cover 70 covers the massage module 100b, the hollow space 931 defines a groove 18, which only provides with the first opening 9311. The massage head 30 is movably installed within the groove 18 and the one end of the massage head 30 extends and exposes outside the shell 90 through the first opening 9311.

The first cover 71 covers the handle housing 91, the outer wall of the support arms 93 and at least a portion of the opposite inner wall of the support arms 93. The second cover 73 covers the massage head 30 and the extension bar 45. One end of the second cover 73a is connected to the handle housing 91 and the other end is not connected to the bottom of the head portion 10.

The second cover 73a is a folding structure. Thus, in the first direction X of the shell 90, when the massage head 30 moves from the handle housing 91 towards the head portion 10, the portion of the second cover 73a far from the head portion 10 is stretched. When the massage head 30 moves from the head portion 10 towards the handle housing 91, the portion of the second cover 73a far from the head portion 10 is compressed, so as to move telescopically follow the massage head 30.

The second cover 73a is made of a flexible material with elasticity, thereby the second cover 73a that envelopes the ends of the massage head 30 is protruding. Furthermore, when the massage head 30 reciprocating move under the second cover 73a with respect to the shell 90, the second cover 73a does not prevent the massage head 30 from moving.

Also, the massage module 100b according to the present embodiment configured as described above can achieve advantages similar to those by the first embodiment.

### Fourth Embodiment

A description is given next of a fourth embodiment. For the sake of convenience of explanation, parts identical to those in the foregoing first embodiment shown in FIG. 1 to FIG. 12 are denoted by identical reference signs and are not described again for brevity. This embodiment is different in structure of the massage head 30 and the movement space 17.

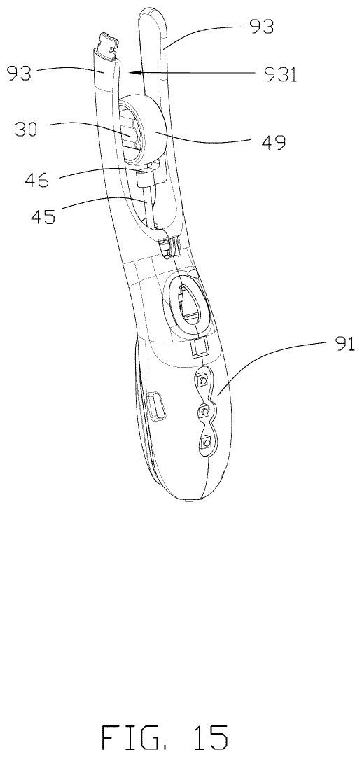

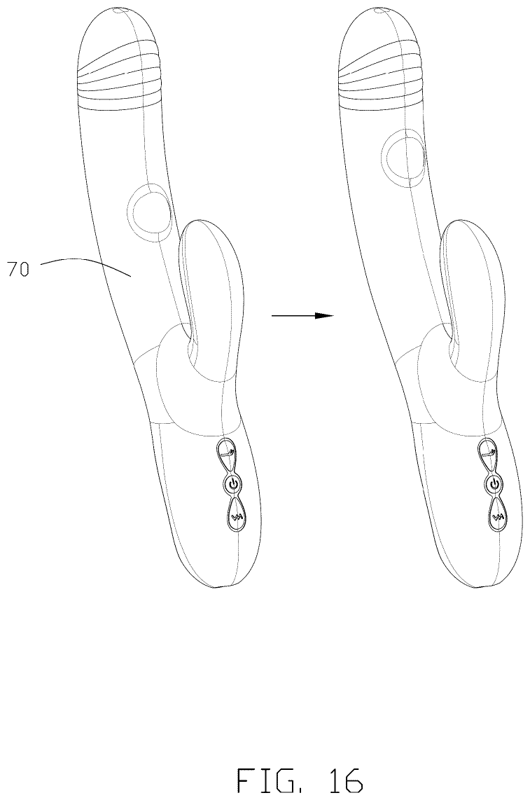

Referring to FIG. 3, FIG. 15 and FIG. 16, in this embodiment, the hollow space 931 is formed between the two support arms 93 and provides with the first opening 9311 and the opposite second opening 9313. As the cover 70 covers the massage module 100c, the massage module 100c does not form a movement space 17. The massage head 30 is movably installed within the hollow space 931 and at least one end of the massage head 30 extend and expose outside the shell 90.

The cover 70 covers the handle housing 91, the outer wall of the support arms 93, the first opening 9311 and the second opening 9313. The cover 70 also covers at least a portion of the massage head 30. The side of the raised portion 31 covered by the cover 70 will be lifted, wherein the cover 70 being lifted will change as the stimulating part 30 slides in the hollow space 931.

In this embodiment, massage module 100c also includes a buckle bar 46 and a roller 47. The buckle bar 46 is U-shaped and the roller is round. One end of the buckle bar 46 is connected to the one end of the extension bar 45, and the other end bypasses the roller 47 and is directly connected to the massage head 30. The massage head 30 is installed within the roller 47. When the extension bar 45 moving along the first direction X, the buckle bar 46 and the massage head 30 simultaneously moving along the first direction X. The massage head 30 drives the roller 47 to move, thereby the roller 47 can rotate with respect to the cover 70.

Also, the massage module 100c according to the present embodiment configured as described above possess roll massage mode, which can achieve a better massage effect.

### Fifth Embodiment

A description is given next of a fifth embodiment. For the sake of convenience of explanation, parts identical to those in the foregoing first embodiment shown in FIG. 1 to FIG. 11 are denoted by identical reference signs and are not described again for brevity. This embodiment is different in structure of the second cover 73b.

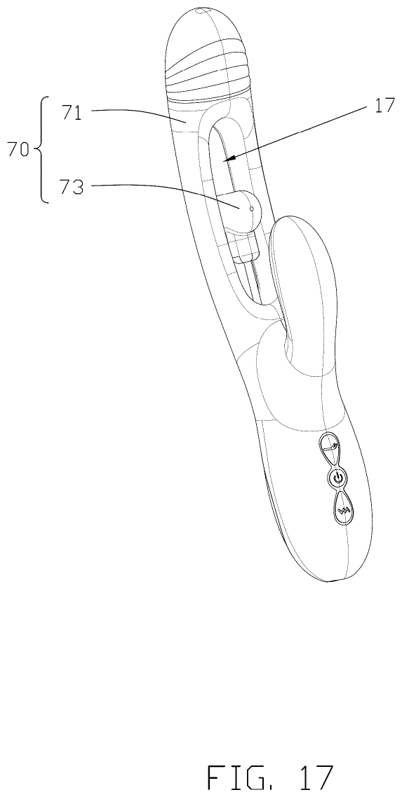

Referring to FIG. 1, FIG. 3 and FIG. 17, in this embodiment, the hollow space 931 is formed between the two support arms 93 and provides with the first opening 9311 and the opposite second opening 9313. As the cover 70 covers the massage module 100d, the hollow space 931 defines the movement space 17, which also provides with the first opening 9311 and the opposite second opening 9313. The massage head 30 is movably installed within the movement space 17 and the two ends of the massage head 30 extend and expose outside the shell 90 through the first opening 9311 and the second opening 9313.

The first cover 71 covers the handle housing 91 and the support arms 93. The second cover 73b covers the massage head 30 and at least a portion of the extension bar 45. Both two ends of the second cover 73b is not connected to the shell 90, that is, the first cover 71 and the second cover 73b are not integrally formed structure.

Also, the massage module 100d according to the present embodiment configured as described above can achieve advantages similar to those by the first embodiment.

The five embodiments presented above show multiple structures of the cover 70 and multiple forms of the massage head 30. In the description of the present disclosure, the cover 70 having three structures. The first one is the cover 70 completely covers the two support arms 93, such as the first embodiment, the second embodiment and the fifth embodiment. The second one is the cover 70 covers a portion of the support arms 93, such as the third embodiment. The third one is the cover 70 covers at least one protruding end of the massage head 30 and does not cover the opposite inner wall of the support arms 93, such as the fourth embodiment. It can be understood that the structures of the cover 70 are not limited to the above three, such as the cover 70 completely does not cover the massage head 30.

In the description of the present disclosure, the massage head 30 having three forms. The first form is two ends of the massage head 30 protruding outside the shell 90. The second form is only one end of the massage head 30 protruding outside the shell 90. The third form is both two ends of the massage head 30 do not protrude outside the shell 90. It can be understood that the forms of the massage head 30 are not limited to the above three.

The contents not described in detail in this specification are known to those skilled in the art.

In the description of the present disclosure, it should be understood that terms such as “center”, “longitudinal”, “lateral”, “length”, “width”, “thickness”, “top”, “bottom”, “front”, “rear”, “left”, “right”, “vertical”, “horizontal”, “upper”, “lower”, “inner”, “outer”, “clockwise”, “counterclockwise”, etc., indicate the orientation or positional relationship based on the orientation or positional relationship shown in the drawings. These terms are used for descriptive purposes and are not to be construed as limiting, indicating, or implying any particular orientation, construction or operation for the devices or arms referred to. Therefore, it should be understood that the terms “first,” “second,” etc., are used for descriptive purposes only and do not imply or suggest any relative importance or indicate the quantity of technical features indicated.

The foregoing illustrates and describes the basic principles and main features of the present disclosure and its advantages. Those skilled in the art should understand that the present disclosure is not limited to the embodiments described above. The embodiments and descriptions in the specification are intended only to illustrate the principles of the present disclosure. Within the scope and spirit of the present disclosure, various modifications and improvements can be made which fall within the scope of protection defined by the appended claims and their equivalents.

1. A massage module comprising:
a head portion configured to be inserted into a vagina along an insertion direction so as to provide a first stimulus to the vagina,
a handle; and
a connecting portion connected between the head portion and the handle, and the connecting portion comprising a sub-massage portion configured to be inserted into the vagina following with an insertion action of the head portion and configured to provide a second stimulus to the vagina, the sub-massage portion comprising:
a housing;
a recess formed in the housing and concaved in a thickness direction of the housing, the recess defining a movement space and a first opening intercommunicating the movement space inside the housing to an exterior space outside of the housing,
a driving device received in a cavity defined in the handle, the cavity communicating with the movement space; and
a massage head accommodated in the movement space,
wherein at least a portion of the massage head protrudes out of the movement space via the first opening, and the driving device includes a first shaft which is at least partly received in the movement space and is coupled to the massage head, wherein the first shaft is configured for doing a reciprocal motion along in a linear direction in the movement space and driving the at least a portion of the massage head to move reciprocally in the linear direction in the movement space, so as to generate the second stimulus.

2-4. (canceled)

5. The massage module according to claim 1, wherein the recess includes opposite inner walls each of which faces the moving space and extends along the linear direction, a gap is formed between each of the opposite inner walls and the massage head, thereby preventing the massage head from contacting the opposite inner walls.

6. The massage module according to claim 1, wherein the recess penetrates through the housing at an upper side of the housing and at a lower side of the housing, so as to form the first opening at the upper side of the housing and a second opening at the lower side of the housing, and the massage head partly protrudes out of the housing from each of the first opening and the second opening.

7. The massage module according to claim 6, wherein the massage module further includes a cover, and the cover covers the first opening, the second opening, and the massage head.

8. The massage module according to claim 6, wherein the massage module further comprises a vice massage portion which is located out of the vagina while the massage head is inserted in the vagina, and
the first opening closer to the vice massage portion than the head portion.

9. (canceled)

10. A massage module comprising:
a shell configured to be inserted into a vagina along an insertion direction, the shell defining a movement space therein, a lateral wall of the shell defining a first opening to intercommunicate the movement space inside the shell with an exterior space out of the shell, wherein the lateral wall extends along an insertion direction of the shell;
a driving device arranged in a cavity of the shell which is adjacent to the movement space, wherein the cavity is defined by an interior surface of the shell and the movement space is defined by a surface of the shell that is exterior to an interior surface of the cavity; and
a massage head accommodated in the movement space and driven by the driving device, and wherein at least a portion of the massage head protrudes out of the movement space via the first opening, and the driving device drives the at least a portion of the massage head to do a linear reciprocating motion along the insertion direction;
wherein the driving device comprises a motor and a transmission mechanism, the motor comprises a rotating shaft configured to rotate with respect to the motor, the rotating shaft extends from one end of the motor and connects to the transmission mechanism,
wherein the transmission mechanism comprises a screw, a sliding block and an extension bar, the screw is sleeved on the rotating shaft and provided with a spiral sliding groove, the sliding block is movably sleeved on the screw, one end of the extension bar is connected to the sliding block, and another end of the extension bar is connected to the massage head through the shell, such that the extension bar can drive the massage head,
wherein the sliding block comprises a first portion and a second portion extending and protruding from the first portion, the first portion is sleeved on the screw and the second portion is connected to the extension bar, wherein the second portion defines a through hole, the one end of the extension bar is inserted into the through hole,
wherein the first portion further includes a sliding vane extending from a side wall of the first portion, the interior surface of the shell extends to form a sliding rail along a length direction of the shell, and the sliding vane is engaged into the sliding rail, wherein two walls of the sliding rail play a limit role to the sliding vane, such that the sliding vane slides along the sliding rail,
wherein the sliding block further comprises a plug, a rotating end of the plug is rotatably connected to the first portion, and a sliding end of the plug is slidably arranged in the sliding groove.

11-16. (canceled)

17. The massage module according to claim 10, wherein the massage module further comprises a cover,
the cover includes a first cover and a second cover,
the first cover covers the shell, and the second cover is installed telescopically within the movement space and covers the massage head, such that under the driving of the massage head, the second cover slides reciprocally with respect to the shell.

18. The massage module according to claim 10, wherein the massage module further comprises a cover,
the cover covers the shell, the massage head and the first opening,
the at least a portion of the massage head protruding from the shell contacts the cover, causing a portion of the cover to protrude, and
when the massage head moves reciprocally under the cover with respect to the shell, the cover does not prevent the massage head from moving.

19. The massage module according to claim 18, wherein the shell is made of a first material,
the massage head is made of a second material,
the cover is made of a third material,
an elasticity of the first material is less than an elasticity of the second material, and an elasticity of the third material is more than the elasticity of the second material.

20. (canceled)

21. The massage module according to claim 1, wherein the driving device comprises a motor, a second shaft coupled to the motor and rotatable by driving of the motor, the first shaft is coupled to the second shaft and movable along the linear direction while the second shaft rotates.

22. The massage module according to claim 1, wherein the massage head includes a base unslideably mounted on the first shaft, a first protrusion fastened on a top of the base and protruding out of the housing from the first opening, a vibrator attached to the base and generating vibrations on the first protrusion, so as to apply the vibrations onto the vagina.

23. The massage module according to claim 6, wherein the massage head includes a base unslideably mounted on the first shaft, a first protrusion fastened on a top of the base and protruding out of the housing from the first opening, a second protrusion fastened on a bottom of the base and protruding out of the housing from the second opening, a vibrator attached to the base and capable of generating vibrations on the first protrusion and the second protrusion, so as to apply the vibrations onto the vagina.

24. A massage module comprising:
a head portion configured to be inserted into a vagina,
a handle;
a middle portion extending from the handle to the head portion, and the middle portion has a configuration which defines a movement space between the head portion and the handle,
a motor; and,
a massage head accommodated in the movement space;
wherein at least a portion of the massage head protrudes out of the movement space from a lateral side of the middle portion, and the motor drives the at least a portion of the massage head to do a reciprocating motion in the movement space without directly connecting opposite side surfaces of the moving space which extend along a length of the moving space.

25. The massage module according to claim 24, further comprising a shaft at least partly receiving in the moving space, where in the shaft is coupled to the motor and the massage head, the shaft is reciprocating movable along the length of the moving space.

26. The massage module according to claim 25, wherein the massage head includes a base fastened on the shaft without sliding relative to the shaft, a first protrusion extending from the base and protruding out of the lateral side of the middle portion for massaging the vagina.

27. The massage module according to claim 26, wherein a vibrator attached to the base and movable together with the shaft for generating vibrations on the first protrusion, so as to apply the vibrations onto the vagina.

28. The massage module according to claim 26, wherein a second protrusion extending from the base and protruding out of another lateral side of the middle portion for massaging the vagina.

29. The massage module according to claim 25, further comprising a screw coupled to the motor and rotatable by driving of the motor, a slider sliding on the screw and movable linearly along the length of the moving space, wherein the shaft is couple to the slider and moves together with the slider.

30. The massage module according to claim 25, wherein two first gaps are defined between the opposite side surfaces of the moving space and shaft along the length of the moving space, the two first gaps and the shaft are exposed to an external environment and viewable by a user.

31. The massage module according to claim 30, wherein the shaft has a distal end to which the massage head is attached, a second gap is defined by the distal end of the shaft and a distal end surface of the moving space which is far away the handle, a length of the second gap changes when the shaft moves.
